(19) United States
(12) Patent Application Publication
(10) Pub. No.: US 2019/0308502 A1
(43) Pub. Date: Oct. 10, 2019

(54) PROJECTION DISPLAY DEVICE, METHOD FOR CONTROLLING PROJECTION DISPLAY DEVICE, AND PROGRAM FOR CONTROLLING PROJECTION DISPLAY DEVICE

(71) Applicant: FUJIFILM Corporation, Tokyo (JP)

(72) Inventor: Kazuya YONEYAMA, Saitama (JP)

(73) Assignee: FUJIFILM Corporation, Tokyo (JP)

(21) Appl. No.: 16/441,006

(22) Filed: Jun. 14, 2019

Related U.S. Application Data
(63) Continuation of application No. PCT/JP2017/037665, filed on Oct. 18, 2017.

(30) Foreign Application Priority Data
Jan. 10, 2017 (JP) 2017-002137

(51) Int. Cl. B60K 35/00; G09G 3/00; G06K 9/00; G06T 11/00; G02B 27/01; B60S 1/04

(52) U.S. Cl. CPC B60K 35/00; G09G 3/002; G06K 9/00832; E02F 9/26; G02B 27/0101; B60S 1/04; G02B 2027/014; G06T 11/00

(57) ABSTRACT

A projection display device includes a projection display unit (50) that includes a light modulation unit that projects image light, onto a projection area (11A) of a front windshield (11) for a construction machine (1) to display an image based on the image light. A display control unit (65) performs first display control in which a display position of first display content based on operation support information is limited within an area (110A) that overlaps with a wiped area in the projection area (11A) to be wiped by a windshield wiper (14) and in which a display position of second display content based on related information whole relation with operation is low is limited within an area (111A) that overlaps with the non-wiped area in the projection area (11A) not to be wiped by the windshield wiper (14).

### CROSS-REFERENCE TO RELATED APPLICATIONS

This application is a Continuation of PCT International Application No. PCT/JP2017/037665 filed on Oct. 18, 2017, which claims priority under 35 U.S.C § 119(a) to Japanese Patent Application No. 2017-002137 filed on Jan. 10, 2017. Each of the above application(s) is hereby expressly incorporated by reference, in its entirety, into the present application.

### BACKGROUND OF THE INVENTION

### 1. Field of the Invention

The present invention relates to a projection display device, a method for controlling the projection display device, and a non-transitory computer readable medium for storing a program for controlling the projection display device.

### 2. Description of the Related Art

A head-up display (HUD) for a vehicle has been known. In the HUD, a windshield of a vehicle or a combiner disposed in front of the windshield is used as a screen, and light is projected onto the screen to display an image. Examples of the vehicle include an automobile, a train, a ship, a construction machine, an aircraft, and an agricultural machine. The HUD enables a driver to visually recognize an image based on the light projected from the HUD as a real image on the screen or as a virtual image ahead of the screen.

In some vehicles in which a windshield is mounted, water due to rain and stain are attached onto the windshield, and thus, a windshield wiper is provided in order to remove the water and stain. The windshield wiper can clean only a part of a region of the windshield even when the windshield wiper works, and a non-wiped area that is not wiped by the windshield wiper is present on the windshield.

JP2005-207778A and JP1995-266925A (JP-H7-266925A) describe an HUD that performs control, at the time a windshield wiper of a vehicle is working, to prohibit display of an image within an area to be wiped by the windshield wiper or to reduce the amount of information to be displayed within the wiped area in order to secure a view ahead of a windshield.

JP1998-281792A (JP-H10-281792A) describes an HUD that reduces information to be displayed at the time a windshield wiper of a vehicle is working, thereby securing a view ahead of a windshield.

With a vehicle such as a heavy machine, a construction machine, or an agricultural machine, unlike a normal vehicle such as an automobile, operation is performed at a determined location. Thus, the vehicle body is unlikely to travel a long distance on a public road during the operation. That is, in the heavy machine, the construction machine, or the agricultural machine, the scene ahead of a windshield does not largely change during the operation. Thus, even in a situation where the view ahead of the windshield is narrowed because a windshield wiper is working due to rain, snow, or the like, it is more important to continue display of information for supporting the operation without reducing the amount of the information than to secure the forward view.

The HUDs described in JP2005-207778A, JP1995-266925A (JP-H7-266925A), and JP1998-281792A (JP-H10-281792A) reduce the amount of information to be displayed or prohibit display of information within the area to be wiped by the windshield wiper when the windshield wiper is working. Thus, there is a possibility that sufficient information cannot be provided for a driver while the windshield wiper is working.

### SUMMARY OF THE INVENTION

The present invention has been made in view of the above circumstances, and an object is to provide a projection display device that can provide sufficient information for a driver of a vehicle in which a windshield wiper is mounted, a method for controlling the projection display device, and a non-transitory computer readable medium for storing a program for controlling the projection display device.

A projection display device according to the present invention is a projection display device including a projection display unit and a display control unit. The projection display unit includes a light modulation unit that, on the basis of image information to be input, spatially modulates light emitted from a light source, and projects image light, obtained through the spatial modulation, onto a predetermined projection area of a projection surface of a vehicle to display an image based on the image light. The display control unit controls the image information to be input to the light modulation unit and that controls the image that is to be displayed by the projection display unit. The projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper. Priority is set for each of a plurality of pieces of display content that is displayable by the projection display unit. The display control unit performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

A method for controlling a projection display device according to the present invention is a method for controlling a projection display device, the projection display device having a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light, the method including a display control step of controlling the image information to be input to the light modulation unit and controlling the image that is to be displayed by the projection display unit. The projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper. Priority is set for each of a plurality of pieces of display content that is displayable by the projection display unit. The display control step performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

A program for controlling a projection display device according to the present invention is a program for controlling a projection display device, the projection display device having a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light, the program causing a computer to execute a display control step of controlling the image information to be input to the light modulation unit and controlling the image that is to be displayed by the projection display unit. The projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper. Priority is set for each of a plurality of pieces of display content that is displayable by the projection display unit. The display control step performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

According to the present invention, it is possible to provide a projection display device that can provide sufficient information for an operator of a vehicle in which a windshield wiper is mounted, a method for controlling the projection display device, and a non-transitory computer readable medium for storing a program for controlling the projection display device.

### BRIEF DESCRIPTION OF THE DRAWINGS

FIG. 1 is a schematic diagram illustrating a schematic configuration of a construction machine 1 in which an HUD 10 that is an embodiment of a projection display device according to the present invention is mounted;

FIG. 2 is a schematic diagram illustrating an internal configuration example of a driver's cabin 5 in the construction machine 1 illustrated in FIG. 1;

FIG. 3 is a schematic diagram illustrating a state of a front windshield 11 when seen from a driver's seat 6 in the driver's cabin 5 in the construction machine 1 illustrated in FIG. 1;

FIG. 4 is a schematic diagram illustrating an internal configuration of the HUD 10 illustrated in FIGS. 1 and 2;

FIG. 5 is a functional block diagram of a system control unit 60 illustrated in FIG. 4;

FIG. 6 is a diagram illustrating a display example in a case where first display control is performed in the HUD 10;

FIG. 7 is a diagram illustrating a display example in a case where a bucket 4A is moved downward from the display state illustrated in FIG. 6;

FIG. 8 is a diagram illustrating a display example in a case where the bucket 4A is moved upward from the display state illustrated in FIG. 6;

FIG. 9 is a diagram illustrating a display example in a case where the bucket 4A is moved upward from the display state illustrated in FIG. 8;

FIG. 10 is a diagram illustrating a display example in a case where second display control is performed in the HUD 10;

FIG. 11 is a diagram illustrating a display example in a case where the bucket 4A is moved upward from the display state illustrated in FIG. 10; and

FIG. 12 is a flowchart for describing operations of the system control unit 60 illustrated in FIG. 5.

### DESCRIPTION OF THE PREFERRED EMBODIMENTS

Now, an embodiment of the present invention will be described with reference to the drawings.

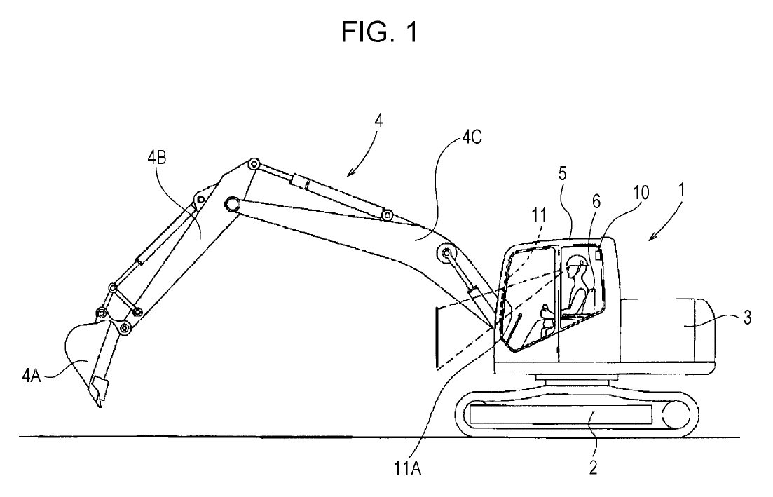

FIG. 1 is a schematic diagram illustrating a schematic configuration of a construction machine 1 in which an HUD 10 that is an embodiment of the projection display device according to the present invention is mounted.

The construction machine 1 is a hydraulic shovel and is composed of units such as an undercarriage 2, an upper rotatable body 3 that is supported by the undercarriage 2 in a rotatable manner, and a front operation unit 4 that is supported by the upper rotatable body 3. The undercarriage 2 and the upper rotatable body 3 constitute a main body part of the construction machine 1.

The undercarriage 2 includes a metal or rubber crawler for traveling on a public road or in a construction site.

The upper rotatable body 3 includes a driver's cabin 5 in which a control device for controlling the front operation unit 4 and a driver's seat 6 for an operator to be seated are set.

The front operation unit 4 includes an arm 4C, a boom 4B, and a bucket 4A. The arm 4C is supported by the upper rotatable body 3 such that the arm 4C is movable in the gravity direction and a direction perpendicular to the gravity direction (vertical direction in the drawing and direction perpendicular to the drawing). The boom 4B is supported by the arm 4C such that the boom 4B is rotatable relative to the arm 4C. The bucket 4A is supported by the boom 4B such that the bucket 4A is rotatable relative to the boom 4B. The bucket 4A is a part that can directly contact a target such as the earth or an object to be carried and constitutes a working machine.

Note that instead of the bucket 4A, another working machine, such as a steel frame cutting machine, a concrete crushing machine, a grabbing machine, or a hitting breaker, may be attached to the boom 4B.

The bucket 4A is movable in the vertical direction of the drawing relative to the driver's cabin 5 via the arm 4C and the boom 4B. In addition, the bucket 4A is rotatable around axes that are the line-of-sight direction of the operator who is seated on the driver's seat 6 and a direction perpendicular to the gravity direction. In addition, the boom 4B is rotatable around an axis that is perpendicular to the drawing.

Although omitted from the illustration, a group of sensors (sensors 80 that will be described later) such as an angular rate sensor and a three-axis acceleration sensor for detecting the posture of the bucket 4A is provided in the front operation unit 4.

The driver's cabin 5 is provided with the front windshield 11 ahead of the driver's seat 6, and a part of the front windshield 11 is a region processed to reflect image light, which will be described later. Furthermore, this region constitutes a projection area 11A onto which image light emitted from the HUD 10 is projected.

The HUD 10 is set within the driver's cabin 5 and displays a virtual image with image light projected onto the projection area 11A, which is a predetermined part of a region in the front windshield 11 constituting a projection surface, so that the operator who is seated on the driver's seat 6 can visually recognize the virtual image ahead of the front windshield 11.

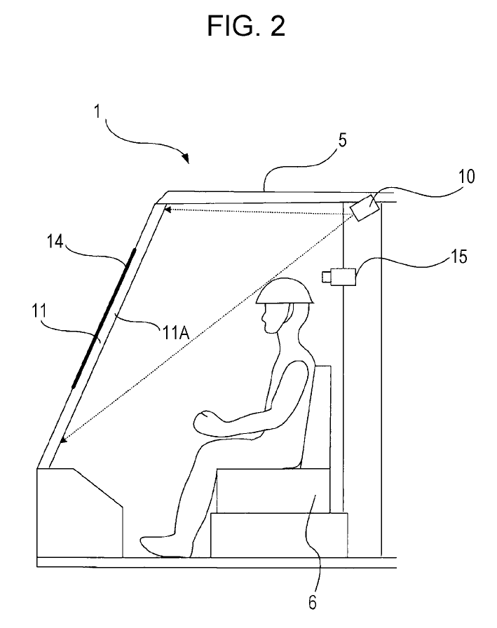

FIG. 2 is a schematic diagram illustrating an internal configuration example of the driver's cabin 5 in the construction machine 1 illustrated in FIG. 1.

As illustrated in FIG. 2, the HUD 10 is provided above and behind the operator in a state where the operator is seated on the driver's seat 6. Note that the arrangement position of the HUD 10 is not limited to this, and the HUD 10 may be arranged on the ceiling of the driver's cabin 5 above the driver's seat 6 or on the floor of the driver's cabin 5 ahead of the driver's seat 6.

By seeing image light that has been projected onto and reflected on the projection area 11A of the front windshield 11, the operator of the construction machine 1 can visually recognize, as a virtual image, information such as an icon or characters for supporting the operation by using the construction machine 1. The projection area 11A has a function of reflecting the image light projected from the HUD 10 and transmitting light from the outdoor space (the outside) at the same time. Thus, the operator can visually recognize the virtual image based on the image light projected from the HUD 10, the virtual image overlapping with the outside scene.

An image capturing unit 15 is provided within the driver's cabin 5 behind the operator in a state where the operator is seated on the driver's seat 6. The image capturing unit 15 has an image sensor and an image processing unit that processes captured image signals output from the image sensor to generate captured image data.

The image capturing unit 15 captures an image of at least the projection area 11A of the front windshield 11. The image capturing unit 15 is connected to the HUD 10 wirelessly or via wire, and transfers captured image data obtained by capturing an image of the projection area 11A to the HUD 10.

Note that the set location of the image capturing unit 15 may be anywhere as long as an image of the projection area 11A can be captured.

The driver's cabin 5 is equipped with a windshield wiper 14 for wiping the outer surface of the front windshield 11 to remove water drops, stain, or the like attached onto the outer surface.

Although the HUD 10 is mounted in the hydraulic shovel for use in the example in FIG. 1, for example, the HUD 10 may be similarly mounted in any vehicle in which a windshield wiper is mounted, such as a working machine (e.g., a wheel loader, a bulldozer, a motor grader, or a forklift), an automobile, a train, an aircraft, or a ship.

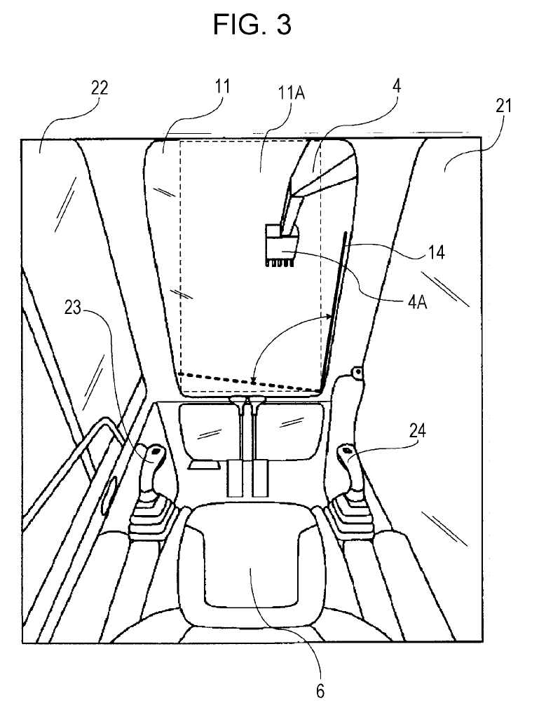

FIG. 3 is a schematic diagram illustrating a state of the front windshield 11 when seen from the driver's seat 6 in the driver's cabin 5 in the construction machine 1 illustrated in FIG. 1.

The driver's cabin 5 is surrounded by the front windshield 11, a right-side windshield 21, and a left-side windshield 22. The driver's cabin 5 includes a left control lever 23, a right control lever 24, and the like around the driver's seat 6. The left control lever 23 is for controlling folding and stretching of the front operation unit 4. The right control lever 24 is for controlling digging and releasing of the bucket 4A in the front operation unit 4.

The windshield wiper 14 for wiping out water or stain due to rain or the like attached onto the front windshield 11 is provided on the front surface of the front windshield 11. The windshield wiper 14 is configured to be movable between the position of a solid line and the position of a dashed line in the drawing, and wipes a part of the outer surface of the front windshield 11.

The front windshield 11 has the projection area 11A onto which the image light emitted from the HUD 10 is projected, and the projection area 11A reflects the image light and transmits light from the outdoor space (the outside) at the same time. A part of a wiped area of the front windshield 11 to be wiped out by the windshield wiper 14 and a part of a non-wiped area of the front windshield 11 not to be wiped by the windshield wiper 14 overlap with the projection area 11A in a state seen from the driver's seat 6 (eye box set in a space above the driver's seat 6).

That is, the projection area 11A is composed of, in a state seen from the driver's seat 6, an area (hereinafter called overlapping wiped area) that overlaps with the wiped area to be wiped by the windshield wiper 14 and an area (hereinafter called overlapping non-wiped area) that overlaps with the non-wiped area not to be wiped by the windshield wiper 14.

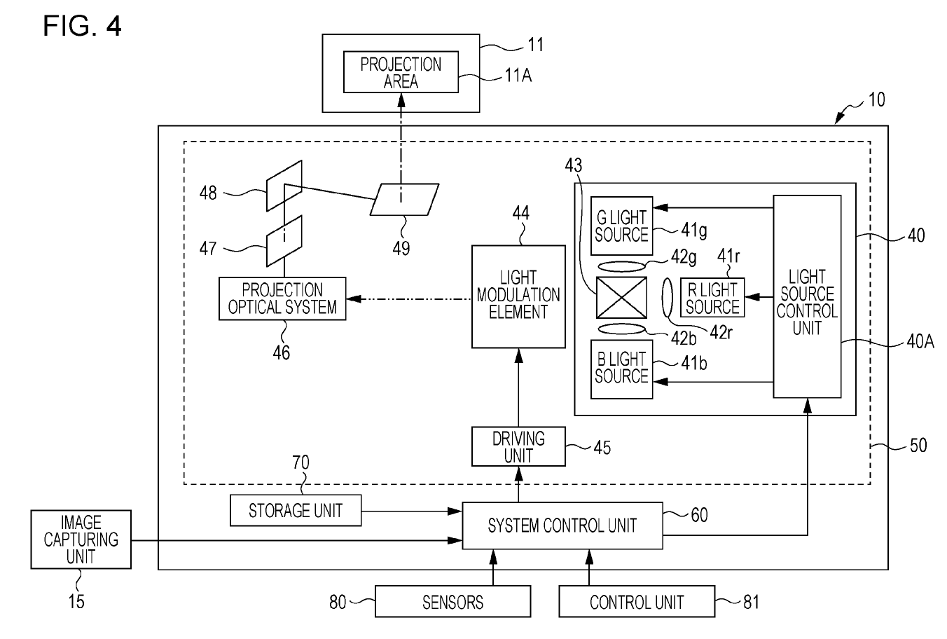

FIG. 4 is a schematic diagram illustrating an internal configuration of the HUD 10 illustrated in FIGS. 1 and 2.

The HUD 10 includes a light source unit 40, a light modulation element 44, a driving unit 45 that drives the light modulation element 44, a projection optical system 46, a diffusion plate 47, a reflective mirror 48, a magnifying glass 49, a system control unit 60 that controls the light source unit 40 and the driving unit 45, and a storage unit 70 that may be composed of a storage medium such as a flash memory.

The light source unit 40 includes a light source control unit 40A, an R light source 41r, a G light source 41g, a B light source 41b, a dichroic prism 43, a collimator lens 42r, a collimator lens 42g, and a collimator lens 42b. The R light source 41r is a red light source that emits red light, the G light source 41g is a green light source that emits green light, and the B light source 41b is a blue light source that emits blue light. The collimator lens 42r is provided between the R light source 41r and the dichroic prism 43, the collimator lens 42g is provided between the G light source 41g and the dichroic prism 43, and the collimator lens 42b is provided between the B light source 41b and the dichroic prism 43.

The dichroic prism 43 is an optical member for guiding light emitted from each of the R light source 41r, the G light source 41g, and the B light source 41b to the same optical path. That is, the dichroic prism 43 transmits red light collimated by the collimator lens 42r and emits the red light to the light modulation element 44. In addition, the dichroic prism 43 reflects green light collimated by the collimator lens 42g and emits the green light to the light modulation element 44. Furthermore, the dichroic prism 43 reflects blue light collimated by the collimator lens 42b and emits the blue light to the light modulation element 44. The optical member having such a function is not limited to the dichroic prism. For example, a cross dichroic mirror may also be used.

For each of the R light source 41r, the G light source 41g, and the B light source 41b, a light emitting element such as a laser or a light emitting diode (LED) is used. The R light source 41r, the G light source 41g, and the B light source 41b constitute a light source of the HUD 10. Although the light source of the HUD 10 includes three light sources, which are the R light source 41r, the G light source 41g, and the B light source 41b, in this embodiment, the number of light sources may be one, two, or four or more.

The light source control unit 40A sets the light emission amount of each of the R light source 41r, the G light source 41g, and the B light source 41b to a predetermined light emission amount pattern, and performs control so as to cause the R light source 41r, the G light source 41g, and the B light source 41b to sequentially emit light in accordance with the light emission amount pattern.

The light modulation element 44 spatially modulates the light emitted from the dichroic prism 43 on the basis of image information and emits the spatially modulated light (red image light, blue image light, and green image light) to the projection optical system 46.

As the light modulation element 44, for example, a liquid crystal on silicon (LCOS), a digital micromirror device (DMD), a micro electro mechanical systems (MEMS) element, a liquid crystal display element, or the like can be used.

On the basis of image information that is input from the system control unit 60, the driving unit 45 drives the light modulation element 44 to cause light (red image light, blue image light, and green image light) in accordance with image information to be emitted from the light modulation element 44 to the projection optical system 46.

The light modulation element 44 and the driving unit 45 constitute a light modulation unit of the HUD 10.

The projection optical system 46 is an optical system for projecting the light emitted from the light modulation element 44 onto the diffusion plate 47. This optical system is not limited to a lens, and a scanner can also be used. For example, light emitted from a scanner may be diffused by the diffusion plate 47 to form a plane light source.

The reflective mirror 48 reflects the light diffused by the diffusion plate 47 toward the magnifying glass 49.

The magnifying glass 49 enlarges and projects an image based on the light reflected on the reflective mirror 48 onto the projection area 11A.

The light source unit 40, the light modulation element 44, the driving unit 45, the projection optical system 46, the diffusion plate 47, the reflective mirror 48, and the magnifying glass 49 constitute a projection display unit 50. The projection display unit 50 spatially modulates light emitted from the R light source 41r, the G light source 41g, and the B light source 41b on the basis of image information that is input from the system control unit 60 and projects the spatially modulated image light onto the projection area 11A to display a virtual image based on the image light.

The system control unit 60 controls the light source control unit 40A and the driving unit 45 so as to cause image light based on image information to be emitted to the diffusion plate 47 through the projection optical system 46.

The diffusion plate 47, the reflective mirror 48, and the magnifying glass 49 illustrated in FIG. 4 are optically designed such that an image based on the image light projected onto the projection area 11A can be visually recognized as a virtual image at a position ahead of the front windshield 11. However, the optical design may also be made such that the image based on the image light projected onto the projection area 11A can be visually recognized as an actual image on the front windshield 11.

The system control unit 60 is mainly composed of a processor and includes a read only memory (ROM) in which a program to be executed by the processor or the like is stored, a random access memory (RAM) as a work memory, and the like.

The storage unit 70 stores a plurality of pieces of display information as raw data of display content to be displayed by the projection display unit 50. The display information includes operation support information for supporting efficient progress of the operation by being displayed in the vicinity of the bucket 4A, which is often observed by the operator during the operation, and related information that is not directly related to the operation of the bucket 4A.

The operation support information is, for example, information indicating the digging direction of the bucket 4A, information indicating the digging amount (xx m), warning information for notifying the operator of a necessity for paying attention to an obstacle such as a person, or the like.

The related information is, for example, information indicating the current date, information indicating the current time, information indicating the amount of fuel of the construction machine 1, or the like.

In the HUD 10, priority is preset for display content that is an image based on each of the plurality of pieces of display information stored in the storage unit 70. The priority of display content is set to higher value as the related degree with operation support is higher.

Specifically, priority information of greater than or equal to a threshold value is stored in association with operation support information stored in the storage unit 70, and priority information of less than the threshold value is stored in association with the related information. Display content based on the operation support information whose priority is greater than or equal to the threshold value constitutes first display content, and display content based on the related information whose priority is less than the threshold value constitutes second display content.

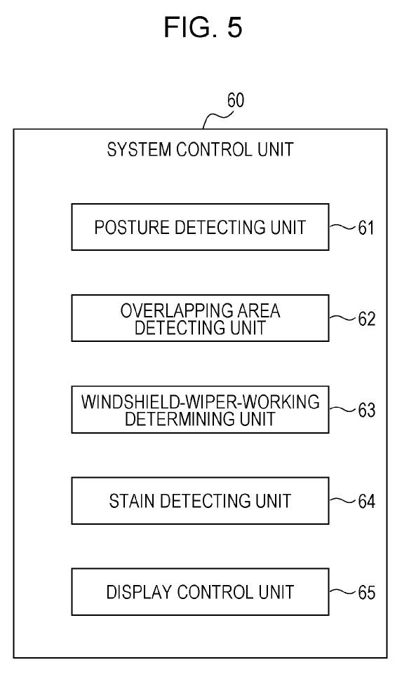

FIG. 5 is a functional block diagram of the system control unit 60 illustrated in FIG. 4.

The system control unit 60 includes a posture detecting unit 61, an overlapping area detecting unit 62, a windshield-wiper-working determining unit 63, a stain detecting unit 64, and a display control unit 65.

The posture detecting unit 61, the overlapping area detecting unit 62, the windshield-wiper-working determining unit 63, the stain detecting unit 64, and the display control unit 65 are functional blocks formed by the processor of the system control unit 60 executing programs including a control program for the HUD 10 stored in the ROM.

On the basis of the acceleration information and angular rate information that are input from the sensors 80, the posture detecting unit 61 detects the posture of the bucket 4A determined on the basis of the position of the bucket 4A in the vertical direction and the distance to the bucket 4A from the driver's cabin 5.

The overlapping area detecting unit 62 detects an overlapping area (hereinafter called bucket overlapping area) of the projection area 11A and the bucket 4A observed from the driver's seat 6.

In the HUD 10, an eye box is set in advance in a space above the driver's seat 6. As long as the operator's eyes are located in the eye box, the operator can visually recognize the virtual image displayed by the projection display unit 50.

In a case where the projection area 11A is observed from the eye box, if the posture of the bucket 4A is known, the bucket overlapping area can be detected because the position of the projection area 11A is fixed.

For example, a table is stored in the storage unit 70. In the table, all possible postures of the bucket 4A and information of the bucket overlapping area in the projection area 11A are associated with each other. In addition, the overlapping area detecting unit 62 detects the bucket overlapping area on the basis of the posture of the bucket 4A detected by the posture detecting unit 61 and the table.

Note that the bucket overlapping area may alternatively be detected by analyzing a captured image obtained by capturing an image of the projection area 11A by using an imaging device (e.g., an imaging device attached to the operator's helmet) set in the vicinity of the eye box.

The windshield-wiper-working determining unit 63 determines whether the windshield wiper 14 is working on the basis of information received from a control unit 81 that generally controls the construction machine 1.

The stain detecting unit 64 compares captured image data acquired from the image capturing unit 15 with reference image data stored in advance to detect the degree of stain in the non-wiped area of the front windshield 11 overlapping with the projection area 11A in a state seen from the driver's seat 6.

For example, an image of the surface of the front windshield 11 in a clean state where no object is attached is captured by the image capturing unit 15, the reference captured image data obtained by the image capturing is stored in the ROM of the system control unit 60, and the stain detecting unit 64 compares the reference captured image data and captured image data that is input from the image capturing unit 15 with each other to detect the degree of stain in the non-wiped area that overlaps with the projection area 11A in the front windshield 11.

Specifically, the stain detecting unit 64 compares first image data corresponding to the non-wiped area in the reference captured image data and second image data corresponding to the non-wiped area in the captured image data that is input from the image capturing unit 15 with each other to detect a change region in which a change in gradation of the second image data with respect to the first image data is large.

If the total area of the change region is greater than or equal to an area threshold value, the stain detecting unit 64 detects that the stain in the non-wiped area is greater than or equal to a stain threshold value; if the total area of the change region is less than the area threshold value, the stain detecting unit 64 detects that the stain in the non-wiped area is less than the stain threshold value.

The display control unit 65 controls the image information to be input to the driving unit 45 and controls the image to be displayed by the projection display unit 50. The display control unit 65 adds the display information read out from the storage unit 70 to the image information, thereby causing the projection display unit 50 to display an image (display content) based on the display information.

On the basis of the operation state of the windshield wiper 14 determined by the windshield-wiper-working determining unit 63 and the degree of stain of the non-wiped area detected by the stain detecting unit 64, the display control unit 65 selectively performs either of first display control and second display control.

The first display control is control in which the display position of the first display content (image based on the operation support information) whose priority is greater than or equal to the threshold value is limited within the overlapping wiped area in the projection area 11A and in which the display position of the second display content (image based on the related information) whose priority is less than the threshold value, is limited within the overlapping non-wiped area in the projection area 11A.

The second display control is control in which the first display content (image based on the operation support information) and the second display content (image based on the related information) are displayed at given positions without limitation in the projection area 11A.

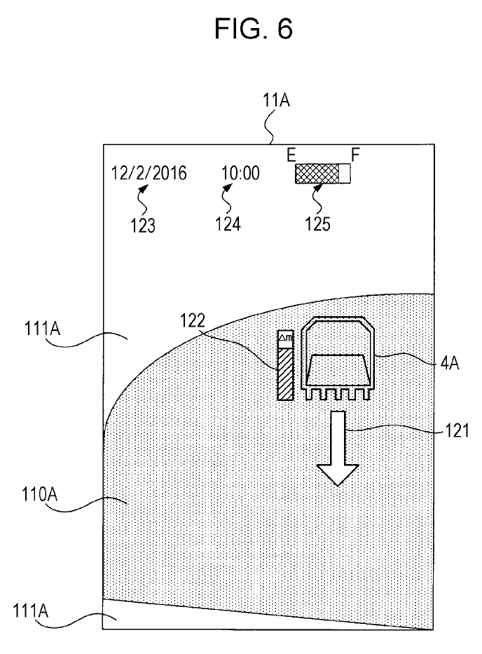

FIG. 6 is a diagram illustrating a display example of a case where the first display control is performed in the HUD 10.

As illustrated in FIG. 6, the projection area 11A is composed of an overlapping wiped area 110A and an overlapping non-wiped area 111A. In FIG. 6, the bucket 4A observed through the projection area 11A from the driver's seat 6 is illustrated.

In the overlapping wiped area 110A, in the vicinity of the bucket 4A (bucket overlapping area detected by the overlapping area detecting unit 62), a gauge image 122 that is the first display content indicating a digging amount and an arrow image 121 that is the first display content indicating a digging direction are displayed.

In the overlapping non-wiped area 111A, a date image 123 that is the second display content indicating the date by using characters, a time image 124 that is the second display content indicating the time by using characters, and a fuel image 125 that is the second display content indicating the amount of fuel of the construction machine 1 are displayed.

In this manner, if the first display control is performed, the display control unit 65 causes the first display content based on the operation support information to be displayed in the overlapping wiped area 110A and not to be displayed in the overlapping non-wiped area 111A. In addition, if the first display control is performed, the display control unit 65 causes the second display content based on the related information to be displayed in the overlapping non-wiped area 111A and not to be displayed in the overlapping wiped area 110A.

Note that causing a given image to be displayed in the overlapping wiped area 110A means projection of light that is spatially modulated on the basis of display information for displaying the given image onto the overlapping wiped area 110A. In addition, causing a given image to be displayed in the overlapping non-wiped area 111A means projection of light that is spatially modulated on the basis of display information for displaying the given image onto the overlapping non-wiped area 111A.

In a case where either the first display control or the second display control is performed, the display control unit 65 causes, in principle, the first display content based on the operation support information to be displayed while maintaining a predetermined positional relationship with the bucket overlapping area detected by the overlapping area detecting unit 62. However, if the first display control is being performed, the display control unit 65 cancels the positional relationship depending on the position of the bucket overlapping area detected by the overlapping area detecting unit 62.

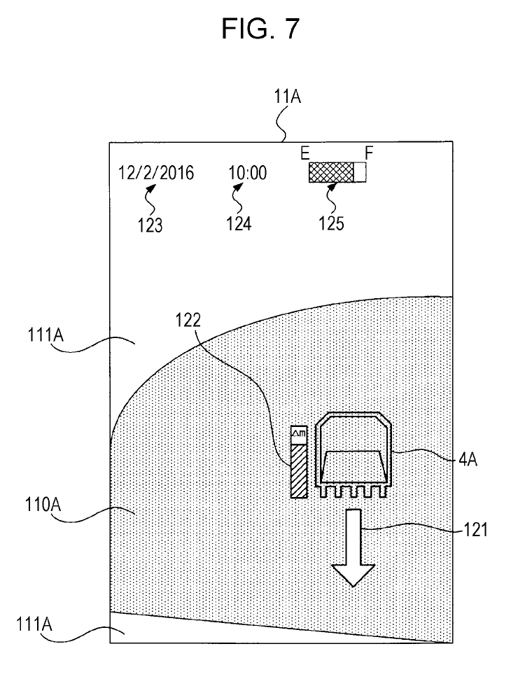

FIG. 7 illustrates a display example in a case where the operator operates the left control lever 23 to move the bucket 4A downward from the display state illustrated in FIG. 6.

At the position of the bucket 4A illustrated in FIG. 7, without changing the positions of the gauge image 122 and the arrow image 121 with respect to the bucket 4A, the gauge image 122 and the arrow image 121 can be displayed in the overlapping wiped area 110A. Thus, the display control unit 65 maintains the relative positions of the gauge image 122 and the arrow image 121 with respect to the bucket 4A in the state of FIG. 6.

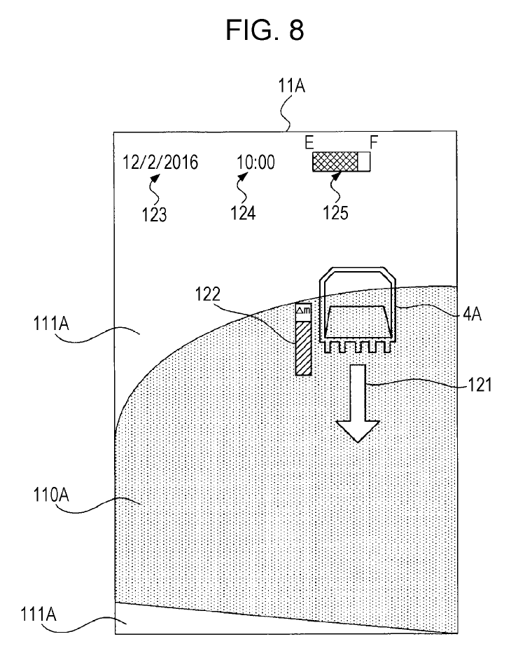

FIG. 8 illustrates a display example in a case where the operator operates the left control lever 23 to move the bucket 4A upward from the display state illustrated in FIG. 6.

At the position of the bucket 4A illustrated in FIG. 8, when the gauge image 122 is displayed in the positional relationship in FIG. 6 on the left of the bucket 4A, the gauge image 122 is displayed across the overlapping wiped area 110A and the overlapping non-wiped area 111A. Thus, in such a case, the display control unit 65 shifts the display position of the gauge image 122 to be lower than the predetermined position with respect to the bucket 4A in order to display the entirety of the gauge image 122 in the overlapping wiped area 110A. On the other hand, at the position of the bucket 4A illustrated in FIG. 8, without changing the position of the arrow image 121 with respect to the bucket 4A, the arrow image 121 can be displayed in the overlapping wiped area 110A. Thus, the display control unit 65 maintains the relative position of the arrow image 121 with respect to the bucket 4A in the state of FIG. 6.

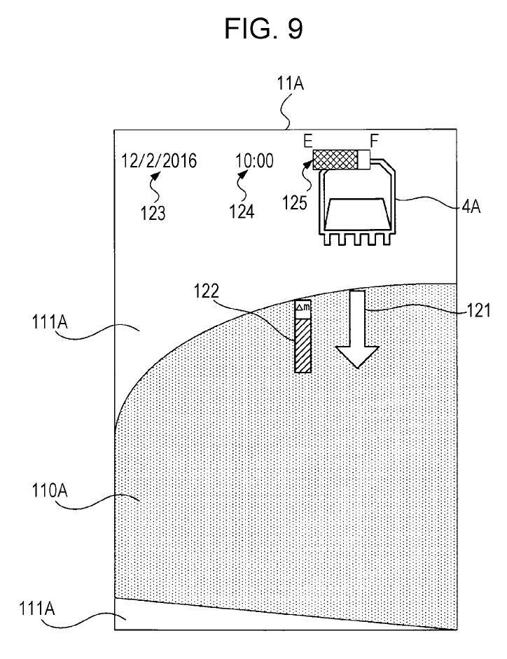

FIG. 9 illustrates a display example in a case where the operator operates the left control lever 23 to move the bucket 4A upward from the display state illustrated in FIG. 8.

At the position of the bucket 4A illustrated in FIG. 9, when the gauge image 122 and the arrow image 121 are displayed in the positional relationship in FIG. 6 with respect to the bucket 4A, the gauge image 122 is displayed in the overlapping non-wiped area 111A, and the arrow image 121 is displayed across the overlapping wiped area 110A and the overlapping non-wiped area 111A. Thus, in such a case, the display control unit 65 shifts the display positions of the gauge image 122 and the arrow image 121 to be lower than the predetermined position with respect to the bucket 4A in order to display the entirety of the gauge image 122 and arrow image 121 in the overlapping wiped area 110A.

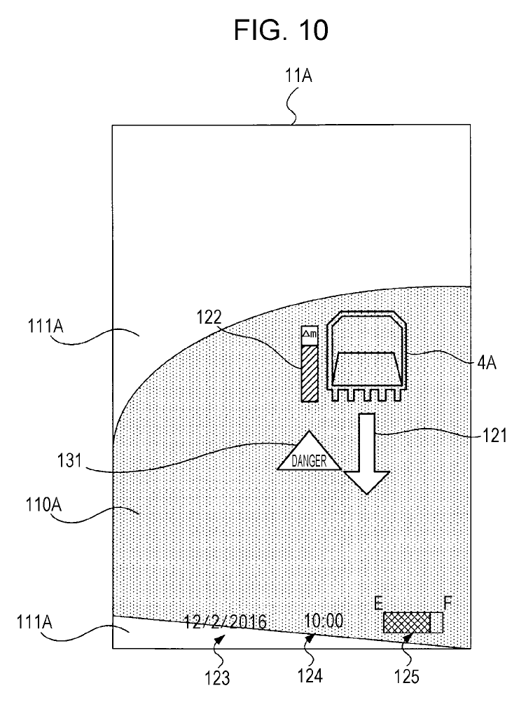

FIG. 10 is a diagram illustrating a display example in a case where the second display control is performed in the HUD 10.

In the overlapping wiped area 110A in FIG. 10, the gauge image 122 and the arrow image 121 that are the first display content and a warning image 131 based on warning information are displayed at predetermined positions with respect to the bucket 4A. On the lower end of the overlapping wiped area 110A, the time image 124 and the fuel image 125 that are the second display content are displayed.

In addition, the date image 123 illustrated in FIG. 10 is the second display content and is displayed across the overlapping wiped area 110A and the overlapping non-wiped area 111A.

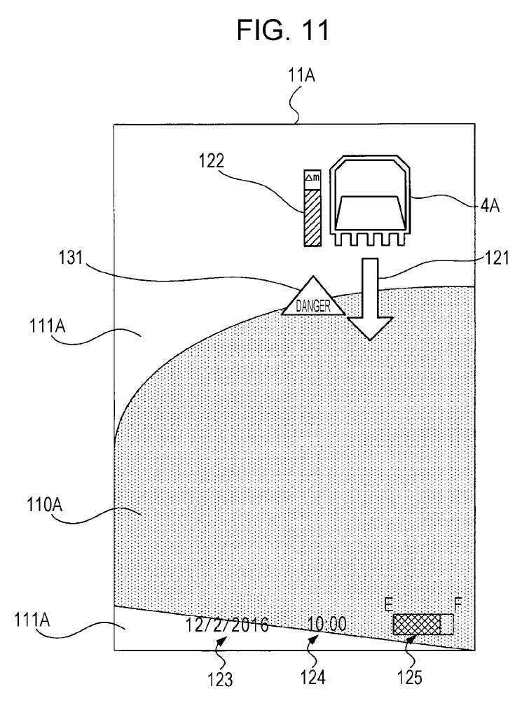

FIG. 11 illustrates a display example in a case where the operator operates the left control lever 23 to move the bucket 4A upward from the display state illustrated in FIG. 10.

The display positions of the gauge image 122, the arrow image 121, and the warning image 131 are not limited in a case where the second display control is performed. Thus, the display control unit 65 maintains the positions of the gauge image 122, the arrow image 121, and the warning image 131 with respect to the bucket 4A in the state of FIG. 10.

In this manner, in a case where the second display control is performed, the display control unit 65 causes the second display content based on the related information to be displayed at a given position in the projection area 11A and causes the first display content based on the operation support information to be displayed at the predetermined position with respect to the bucket 4A. Note that although the first display content is displayed to follow the bucket 4A in the second display control herein, the first display content may be displayed at a given predetermined position in the projection area 11A.

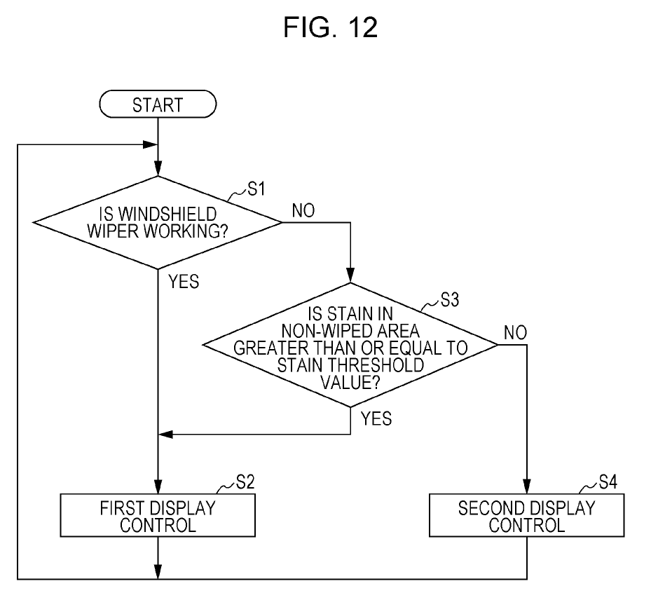

FIG. 12 is a flowchart for describing operations of the system control unit 60 illustrated in FIG. 5. Note that the process illustrated in FIG. 12 is repeatedly executed as long as the power of the HUD 10 is on.

On the basis of information from the control unit 81, the windshield-wiper-working determining unit 63 of the system control unit 60 determines whether the windshield wiper 14 is working (step S1).

If it is determined that the windshield wiper 14 is working (step S1: YES), the display control unit 65 performs the first display control (step S2).

On the other hand, if it is determined that the windshield wiper 14 is stopped (step S1: NO), on the basis of captured image data acquired from the image capturing unit 15 and reference image data stored in advance, the stain detecting unit 64 determines whether the degree of stain in the non-wiped area is greater than or equal to the stain threshold value (step S3).

If the stain detecting unit 64 determines that the degree of stain in the non-wiped area is greater than or equal to the stain threshold value (step S3: YES), the display control unit 65 performs the first display control in step S2.

On the other hand, if the stain detecting unit 64 determines that the degree of stain in the non-wiped area is less than the stain threshold value (step S3: NO), the display control unit 65 performs the second display control (step S4). After step S2 and step S4, the process returns to step S1, and the above operation is repeatedly performed.

As described above, according to the HUD 10, the first display control is performed in a state where the windshield wiper 14 is working, and the first display content based on the operation support information is displayed in the overlapping wiped area 110A that is an area in which the view is secured by the windshield wiper 14. Since the forward view is better in the overlapping wiped area 110A than in the overlapping non-wiped area 111A, the visibility of the first display content can be improved, and the operation efficiency at the time the windshield wiper 14 is working can be improved.

In addition, according to the HUD 10, the first display control is performed in a state where the windshield wiper 14 is working, and the second display content based on the related information other than the operation support information is displayed in the overlapping non-wiped area 111A. Thus, the amount of information displayed by the HUD 10 is not reduced even when the windshield wiper 14 is working, and necessary and sufficient information can be provided for the operator.

In addition, according to the HUD 10, the first display control is performed if, although the windshield wiper 14 is not working, the stain in the non-wiped area of the windshield wiper 14 overlapping with the projection area 11A is strong. For example, the following state will be considered in which, from a state where the windshield wiper 14 is working, rain stops and the windshield wiper 14 is stopped. In this state, water droplets, stain, or the like remains in the non-wiped area. Since the construction machine 1 usually remains in the current site, it takes time for the water droplets or stain to disappear. Thus, the first display control is continued in this state, so that the visibility of the first display content can be secured.

In addition, according to the HUD 10, the second display control is performed if the windshield wiper 14 is stopped and the stain in the non-wiped area is weak. Thus, the first display content can be displayed by using the entirety of the projection area 11A, and the operation can be supported effectively.

The priority of display content is set in advance on a system side in the above description. However, the priority of display content may be manually set by the operator. Thus, at the time the windshield wiper 14 is working, the visibility of necessary information for the operator can be secured.

Note that changing a priority of display content which has the highest priority is preferably prohibited. For example, by fixing the highest priority for warning information, the visibility of the warning image 131 at the time the windshield wiper 14 is working can be secured, and the safety of operation can be improved.

In addition, the display control unit 65 performs either of the first display control and the second display control on the basis of the operation state of the windshield wiper 14 and the degree of stain in the non-wiped area in the above description. However, the present invention is not limited to this.

For example, in FIG. 12, if the determination in step S1 is NO, the process in step S4 may be performed. With this configuration, the detection of stain in the non-wiped area becomes unnecessary, and thus, the manufacturing cost of the HUD 10 can be reduced.

In addition, the operator may instruct by a manual operation, the display control unit 65 to perform either of the first display control and the second display control. This enables display according to the operator's preference or the situation of the operation site that cannot be determined only on the basis of the stain in the non-wiped area.

Furthermore, the display control unit 65 selectively performs the first display control or the second display control in the above description. However, the display control unit 65 may perform only the first display control. With this configuration, the working determination of the windshield wiper 14 and the detection of stain in the non-wiped area become unnecessary, and thus, the manufacturing cost of the HUD 10 can be reduced.

Furthermore, in the configuration described above, the projection display unit 50 projects image light onto the projection area 11A of the front windshield 11. However, a combiner provided between the front windshield 11 and the driver's seat 6 may be used as the projection surface, and the projection display unit 50 may project image light onto a predetermined projection area of the combiner.

In this configuration, in a state seen from the driver's seat 6 (eye box), the projection area of the combiner is composed of an overlapping wiped area and an overlapping non-wiped area. The overlapping wiped area overlaps with a wiped area of the front windshield 11 to be wiped by the windshield wiper 14, and the overlapping non-wiped area overlaps with the non-wiped area of the front windshield 11 not to be wiped by the windshield wiper 14.

In addition, the display control unit 65 selectively performs the first display control or the second display control on the basis of the working state of the windshield wiper 14 determined by the windshield-wiper-working determining unit 63 and the degree of stain in the wiped area of the windshield wiper 14 overlapping with the projection area of the combiner detected by the stain detecting unit 64. In the first display control, the display position of the first display content is limited within the overlapping wiped area in the projection area of the combiner, and the display position of the second display content is limited within the overlapping non-wiped area in the projection area of the combiner. In the second display control, the first display content and the second display content are displayed at given positions within the projection area of the combiner without limitation.

As described above, the following matters are disclosed herein.

(1) A projection display device including:

a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light; and

a display control unit that controls the image information to be input to the light modulation unit and that controls the image that is to be displayed by the projection display unit,

wherein the projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper,

wherein priority is set for each of a plurality of pieces of display content that is displayable by the projection display unit, and

wherein the display control unit performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

(2) The projection display device according to (1),

wherein the display control unit selectively performs the first display control or second display control in which the first display content and the second display content are displayed at given positions in the projection area.

(3) The projection display device according to (2), further including:

a windshield-wiper-working determining unit that determines whether the windshield wiper is working,

wherein, if the windshield wiper is working, the display control unit performs the first display control.

(4) The projection display device according to (2) or (3), further including:

a stain detecting unit that detects stain in the non-wiped area overlapping with the projection area and detects whether the stain in the non-wiped area is greater than or equal to a stain threshold value,

wherein, if a degree of the stain is greater than or equal to the stain threshold value, the display control unit performs the first display control.

(5) The projection display device according to (3), further including:

a stain detecting unit that detects stain in the non-wiped area overlapping with the projection area and detects whether the stain in the non-wiped area is greater than or equal to a stain threshold value,

wherein, if the windshield wiper is stopped and a degree of the stain is less than the stain threshold value, the display control unit performs the second display control.

(6) A method for controlling a projection display device, the projection display device having a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light, the method including:

a display control step of controlling the image information to be input to the light modulation unit and controlling the image that is to be displayed by the projection display unit,

wherein the projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper,

wherein priority is set for each of a plurality of pieces of display content that is displayable by the projection display unit, and

wherein the display control step performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

(7) The method for controlling a projection display device according to (6),

wherein the display control step selectively performs the first display control or second display control in which the first display content and the second display content are displayed at given positions in the projection area.

(8) The method for controlling a projection display device according to (7), further including:

a windshield-wiper-working determining step of determining whether the windshield wiper is working,

wherein, if the windshield wiper is working, the display control step performs the first display control.

(9) The method for controlling a projection display device according to (7) or (8), further including:

a stain detecting step of detecting stain in the non-wiped area overlapping with the projection area and detecting whether the stain in the non-wiped area is greater than or equal to a stain threshold value,

wherein, if a degree of the stain is greater than or equal to the stain threshold value, the display control step performs the first display control.

(10) The method for controlling a projection display device according to (8), further including:

a stain detecting step of detecting stain in the non-wiped area overlapping with the projection area and detecting whether the stain in the non-wiped area is greater than or equal to a stain threshold value,

wherein, if the windshield wiper is stopped and a degree of the stain is less than the stain threshold value, the display control step performs the second display control.

(11) A program for controlling a projection display device, the projection display device having a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light, the program causing a computer to execute:

a display control step of controlling the image information to be input to the light modulation unit and controlling the image that is to be displayed by the projection display unit,

wherein the projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper,

wherein priority is set for each of a plurality of pieces of display content that is displayable by the projection display unit, and

wherein the display control step performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

According to the present invention, it is possible to provide sufficient information for an operator of a vehicle having a windshield wiper.

### REFERENCE SIGNS LIST

1 construction machine
2 undercarriage
3 upper rotatable body
4 front operation unit
4A bucket
4B boom
4C arm
5 driver's cabin
6 driver's seat
10 HUD
11 front windshield
11A projection area
14 windshield wiper
15 image capturing unit
21 right-side windshield
22 left-side windshield
23 left control lever
24 right control lever
40 light source unit
40A light source control unit
41r R light source
41g G light source
41b B light source
42r, 42g, 42b collimator lens
43 dichroic prism
44 light modulation element
45 driving unit
46 projection optical system
47 diffusion plate
48 reflective mirror
49 magnifying glass
50 projection display unit
60 system control unit
61 posture detecting unit
62 overlapping area detecting unit
63 windshield-wiper-working determining unit
64 stain detecting unit
65 display control unit
70 storage unit
80 sensors
81 control unit
110A overlapping wiped area
111A overlapping non-wiped area
121 arrow image
122 gauge image
123 date image
124 time image
125 fuel image
131 warning image

What is claimed is:

1. A projection display device comprising:
a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light; and
a display control unit that controls the image information to be input to the light modulation unit and that controls the image that is to be displayed by the projection display unit,
wherein the projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper,
wherein priority is set for each of a plurality of pieces of display content that is displayable by the projection display unit, and
wherein the display control unit performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

2. The projection display device according to claim 1,
wherein the display control unit selectively performs the first display control or second display control in which the first display content and the second display content are displayed at given positions in the projection area.

3. The projection display device according to claim 2, further comprising:
a windshield-wiper-working determining unit that determines whether the windshield wiper is working,
wherein, if the windshield wiper is working, the display control unit performs the first display control.

4. The projection display device according to claim 2, further comprising:
a stain detecting unit that detects stain in the non-wiped area overlapping with the projection area and detects whether the stain in the non-wiped area is greater than or equal to a stain threshold value,
wherein, if a degree of the stain is greater than or equal to the stain threshold value, the display control unit performs the first display control.

5. The projection display device according to claim 3, further comprising:
a stain detecting unit that detects stain in the non-wiped area overlapping with the projection area and detects whether the stain in the non-wiped area is greater than or equal to a stain threshold value,
wherein, if a degree of the stain is greater than or equal to the stain threshold value, the display control unit performs the first display control.

6. The projection display device according to claim 3, further comprising:
a stain detecting unit that detects stain in the non-wiped area overlapping with the projection area and detects whether the stain in the non-wiped area is greater than or equal to a stain threshold value,
wherein, if the windshield wiper is stopped and a degree of the stain is less than the stain threshold value, the display control unit performs the second display control.

7. A method for controlling a projection display device according to claim 1, the projection display device having a projection display unit that includes a light modulation unit that, on the basis of image information to be input, spatially modulates light emitted from a light source, and that projects image light, obtained through the spatial modulation, onto a predetermined projection area of a projection surface of a vehicle to display an image based on the image light, the method comprising:
a display control step of controlling the image information to be input to the light modulation unit and controlling the image that is to be displayed by the projection display unit,
wherein the projection area overlaps with a wiped area and a non-wiped area in a state seen from a driver's seat of the vehicle, the wiped area being an area to be wiped by a windshield wiper that is mounted in the vehicle for wiping a windshield of the vehicle, the non-wiped area being an area not to be wiped by the windshield wiper,
wherein priority is set for each of a plurality of pieces of display content that is displayable by the projection display unit, and
wherein the display control step performs first display control in which a display position of first display content whose priority is greater than or equal to a threshold value is limited within an area that overlaps with the wiped area in the projection area and in which a display position of second display content whose priority is less than the threshold value is limited within an area that overlaps with the non-wiped area in the projection area.

8. The method for controlling a projection display device according to claim 7,
wherein the display control step selectively performs the first display control or second display control in which the first display content and the second display content are displayed at given positions in the projection area.

9. The method for controlling a projection display device according to claim 8, further comprising:
a windshield-wiper-working determining step of determining whether the windshield wiper is working,
wherein, if the windshield wiper is working, the display control step performs the first display control.

10. The method for controlling a projection display device according to claim 8, further comprising:
a stain detecting step of detecting stain in the non-wiped area overlapping with the projection area and detecting whether the stain in the non-wiped area is greater than or equal to a stain threshold value,
wherein, if a degree of the stain is greater than or equal to the stain threshold value, the display control step performs the first display control.

11. The method for controlling a projection display device according to claim 9, further comprising:
a stain detecting step of detecting stain in the non-wiped area overlapping with the projection area and detecting whether the stain in the non-wiped area is greater than or equal to a stain threshold value,
wherein, if a degree of the stain is greater than or equal to the stain threshold value, the display control step performs the first display control.

12. The method for controlling a projection display device according to claim 9, further comprising:
a stain detecting step of detecting stain in the non-wiped area overlapping with the projection area and detecting whether the stain in the non-wiped area is greater than or equal to a stain threshold value,
wherein, if the windshield wiper is stopped and a degree of the stain is less than the stain threshold value, the display control step performs the second display control.

13. A non-transitory computer readable medium for storing a program for controlling the projection display device according to claim 1, the projection display device having the projection display unit that includes the light modulation unit that, on the basis of image information to be input, spatially modulates light emitted from the light source, and that projects image light, obtained through the spatial modulation, onto the predetermined projection area of the projection surface of the vehicle to display the image based on the image light, the program causing a computer to execute:
a display control step of controlling the image information to be input to the light modulation unit and controlling the image that is to be displayed by the projection display unit,
wherein the projection area overlaps with the wiped area and the non-wiped area in the state seen from the driver's seat of the vehicle, the wiped area being the area to be wiped by a windshield wiper that is mounted in the vehicle for wiping the windshield of the vehicle, the non-wiped area being the area not to be wiped by the windshield wiper,
wherein priority is set for each of the plurality of pieces of display content that is displayable by the projection display unit, and
wherein the display control step performs first display control in which the display position of first display content whose priority is greater than or equal to the threshold value is limited within the area that overlaps with the wiped area in the projection area and in which the display position of second display content whose priority is less than the threshold value is limited within the area that overlaps with the non-wiped area in the projection area.
